(19) United States
(12) Patent Application Publication
(10) Pub. No.: US 2010/0260174 A1
(43) Pub. Date: Oct. 14, 2010

(54) RELAY ACCESS NODE WITH SEPARATE CONTROL AND TRANSPORT SIGNALING FOR SESSION-BASED COMMUNICATIONS

(75) Inventors: Bruno R. PREISS, Waterloo (CA); Giyeong SON, Waterloo (CA); Allan LEWIS, Waterloo (CA)

Correspondence Address: PERRY + CURRIER INC.;(FOR RIM), 1300 YONGE STREET, SUITE 500, TORONTO, ON, M4T-1X3, CA

(73) Assignee: RESEARCH IN MOTION LIMITED, Waterloo (CA)

(21) Appl. No.: 12/420,919

(22) Filed: Apr. 9, 2009

(51) Int. Cl. H04L 12/56

(52) U.S. Cl. 370/389

(57) ABSTRACT

A system and method of control and management of communications between endpoints using access nodes, comprising receiving data at a first access node from a first endpoint using a protocol that does not support session-based communications, initiating a communication session between the first access node and second access node associated with a second endpoint using a transport-independent signaling protocol, wherein the session is uniquely identified using source and destination identifiers and payload type of the data received from the first endpoint, during the communication session between the first access node and second access node controlling routing of data transfer between the first and second endpoints, and terminating the communication session responsive to determining that the transfer of data has stopped.

### FIELD

The present application relates to message routing in a message relay system and, more particularly, to implicit registration and session establishment between client devices that do not support session-based communications.

### BACKGROUND

Message relay systems are known in the art for transferring messages between hosted or enterprise servers and wireless mobile devices. Legacy client-server protocols used in such relay systems typically do not support ad hoc or session-based connections between endpoints, such as provided by peer-to-peer (P2P) computer networks. A P2P computer network uses diverse connectivity between participants in a network and the cumulative bandwidth of network participants rather than conventional centralized resources where a relatively low number of servers provide services to clients. Thus, a pure P2P network is not based on clients or servers but uses only equal peer nodes that simultaneously function as both clients and servers to the other nodes on the network.

Overlay networks are also known in the art for providing custom message routing, increased fault tolerance, and special message delivery semantics such as custodial delivery. An overlay network is a computer network that provides functionality on top of another network, and is typically used when the underlying network infrastructure and protocol characteristics do not match application requirements. A number of different approaches have been explored for message routing in overlay networks. One approach adopts a standard layer-3 routing algorithm for use at layer 7 of the OSI layering model (e.g. routing protocols such as Open Shortest Path First (OSPF), Routing Information Protocol (RIP), and Border Gateway Protocol (BGP)). However, layer-3 algorithms do not handle non-hierarchical addressing very efficiently and are not highly scalable. Another approach is to use ad hoc routing in wireless networks. Unfortunately, ad hoc routing is not scalable beyond several hundred or several thousand nodes. Yet another approach is to use a routing algorithm that is based on a distributed hash table. However, numerous issues remain to be resolved in connection with manageability and scalability of such distributed hash table systems.

Recent developments in P2P and overlay networks present opportunities for enhanced scalability and reliability in the design and implementation of message relay systems, but are subject to the constraints of legacy client-server protocols, as discussed above.

### BRIEF DESCRIPTION OF THE DRAWINGS

Reference will now be made, by way of example, to the accompanying drawings which show example embodiments of the present application, and in which:

FIG. 1 shows, in block diagram form, a prior art message relay system for the control and management of communications between endpoints;

FIG. 2 shows, in block diagram form, a message routing overlay network according to an exemplary embodiment;

FIG. 3 shows, in block diagram form, details of the message routing overlay network of FIG. 2 wherein control signaling and message transport are handled separately;

FIG. 4 is a message flow diagram showing an exemplary exchange of messages over the message routing overlay network of FIGS. 2 and 3 for pushing data from an enterprise server to a handheld mobile communication device; and

FIG. 5 is a message flow diagram showing an exemplary exchange of messages over the message routing overlay network of FIGS. 2 and 3 for sending data from a handheld mobile communication device to an enterprise server.

Similar reference numerals may have been used in different figures to denote similar components.

### DESCRIPTION OF EXAMPLE EMBODIMENTS

In one aspect, the present application provides a message routing overlay system for control and management of communications between endpoints, comprising a plurality of access nodes for communication with associated endpoints, each of said the access nodes including a transport gateway for transport-layer transfer of data between the endpoints using a protocol that does not support session-based communications, and a transport gateway control for application-layer control of message routing of the transfer of data by establishing a communication session that is uniquely identified using source and destination identifiers and payload type of the data; and a plurality of relay services for facilitating implicit session registration and implicit session establishment between a first one of the access nodes and a second one of the access nodes to initiate the communication session responsive to the first one of the access nodes receiving said the source and destination identifiers and payload type from an associated endpoint and terminating the communication session responsive to determining that the transfer of data has stopped.

In another aspect, the present application provides an access node for connecting one of either a client or a server to a message relay system, comprising a transport gateway for transport-layer transfer of data between the one of either client or server and the message relay system using a protocol that does not support session-based communications, and a transport gateway control for application-layer control of message routing of the transfer of data by establishing a communication session that is uniquely identified using source and destination identifiers and payload type of the data.

In yet another aspect, the present application provides a method of control and management of communications between endpoints, comprising receiving data at a first access node from a first one of the endpoints using a protocol that does not support session-based communications, initiating a communication session between the first access node and a second access node associated with a second endpoint using a transport-independent signaling protocol, wherein the session is uniquely identified using source and destination identifiers and payload type of the data received from the first one of the endpoints, during the communication session between the first access node and the second access node controlling routing of data transfer between the first and second endpoints, and terminating the communication session responsive to determining that the transfer of data has stopped.

Other aspects of the present application will be apparent to those of ordinary skill in the art from a review of the following detailed description in conjunction with the drawings.

Embodiments of the present application are not limited to any particular operating system, mobile device architecture, server architecture, or computer programming language.

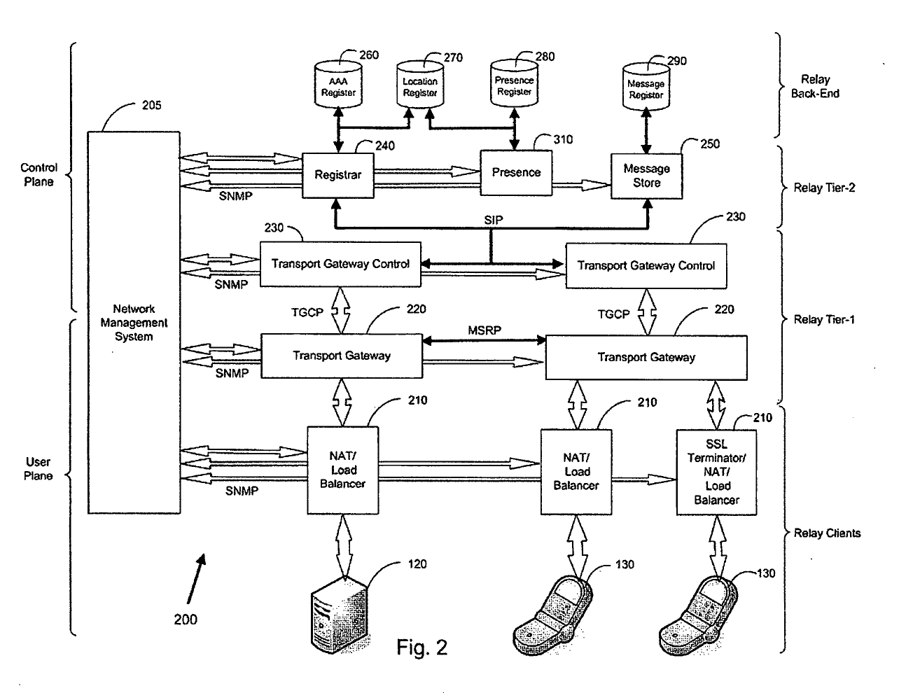

As discussed in greater detail below with reference to FIGS. 2-5, an overlay network is set forth for implementing a session-based communication framework over a legacy message relay system in which control signaling and message transport are handled separately. In an exemplary embodiment, SIP (Session Initiation Protocol) is used to provide application-layer control of message routing. A separate data transport protocol is used to achieve data transfers between access nodes in the message-routing overlay. In order to support legacy client protocols (which do not support separate control and transport signaling), a mechanism of implicit registration and implicit session establishment is provided. According to the exemplary embodiment, a SIP user agent performs SIP registration and SIP session establishment on behalf of each non-SIP client (e.g. enterprise server, handheld mobile communication device, etc.) responsive to implicit triggers, in order to effect a desired message routing.

Unlike prior art overlay networks discussed above, the distributed message-routing overlay set forth herein handles non-hierarchical addressing, is scalable to millions of client endpoints, supports client authentication and authorization as well as enabling (billable) QoS mechanism, and also supports legacy client protocols.

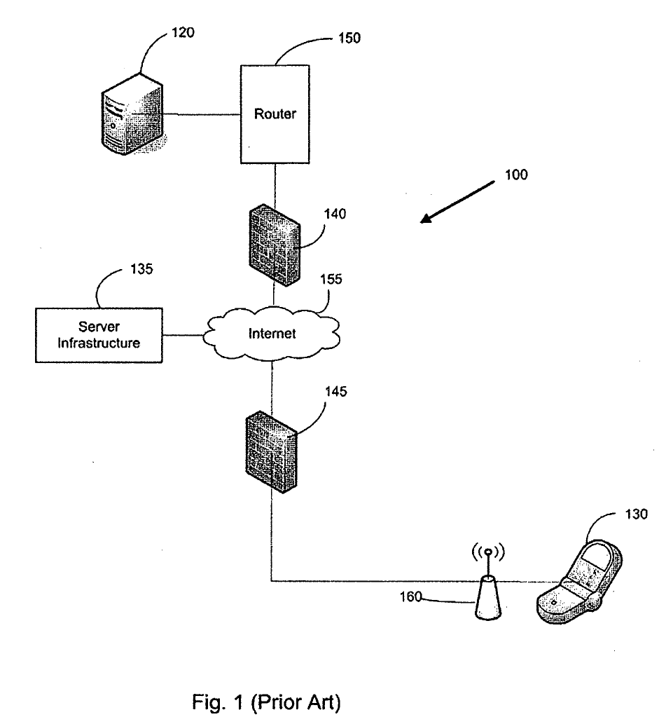

Referring now to FIG. 1, a message relay system 100 is shown, according to the prior art, for control and management of communications between endpoints, such as an enterprise server 120 and a handheld mobile communication device 130. The message relay system 100 conforms to a traditional client-server architecture the operation of which would be well known to a person of ordinary skill in the art.

The enterprise server 120 preferably integrates with one or more additional servers (not shown), such as Microsoft Exchange® IBM® Lotus®, Domino®, Novell® GroupWise®, etc., to enable push-based access to wireless email and data. Enterprise server 120 communicates with a server infrastructure 135 via a router 150 and the Internet 155, through firewall 140. The server infrastructure 135 in turn communicates with a plurality of hand-held mobile communication devices, one such device 130 being illustrated, connected to the server infrastructure 135 through firewall 145 via a wireless network 160 (e.g. GSM/GPRS/EDGE, IDEN, DataTAC, Mobitex, CDMA/EVDO, etc.). Server infrastructure 135 therefore serves as a link between the wired and wireless networks. Data communicated between endpoints (i.e. enterprise server 120 and mobile communication device 130) is preferably encapsulated within messages using a secure protocol (e.g. Secure Multipurpose Internet Mail Extensions (S/MIME)) such that the data remains encrypted at all points between the endpoints (e.g. using FIPS 140-2 validated cryptography).

The message relay system 100 therefore functions essentially as a network of message routing elements that spans the enterprise server 120, the carrier wireless access network 160, server infrastructure 135 and the Internet 155.

Turning briefly to FIG. 2, a message routing overlay system 200 is shown, in accordance with an exemplary embodiment, for control and management of communications between endpoints. The message routing overlay system 200 comprises components in a plurality of functional tiers: Relay Tier-1, Relay Tier-2 and a Relay Back-End, which are separated for the purpose of this application into a Control Plane over which “routing functions” operate, and a User Plane over which “transport functions” operate. The routing functions are those functions that determine what path a message needs to follow through the message routing overlay system 200. The transport functions are those functions relating to reliable transfer of data from one relay component to another within the system 200.

Network Management System 205 functions in a known manner to monitor relay components through the exchange of Simple Network Management Protocol (SNMP) messages, for identifying conditions that require administrative attention.

Within the User Plane, a plurality of Relay Clients, such as enterprise server 120 and handheld mobile communication devices 130, communicate with a plurality of Transport Gateways 220 at associated Relay Tier-1 access nodes, via load balancers 210 for evenly distributing packet traffic across each access node. Data transport between access nodes in Relay Tier-1 (i.e. between the Transport Gateways 220) conforms to a suitable protocol (e.g. Message Session Relay Protocol (MSRP)).

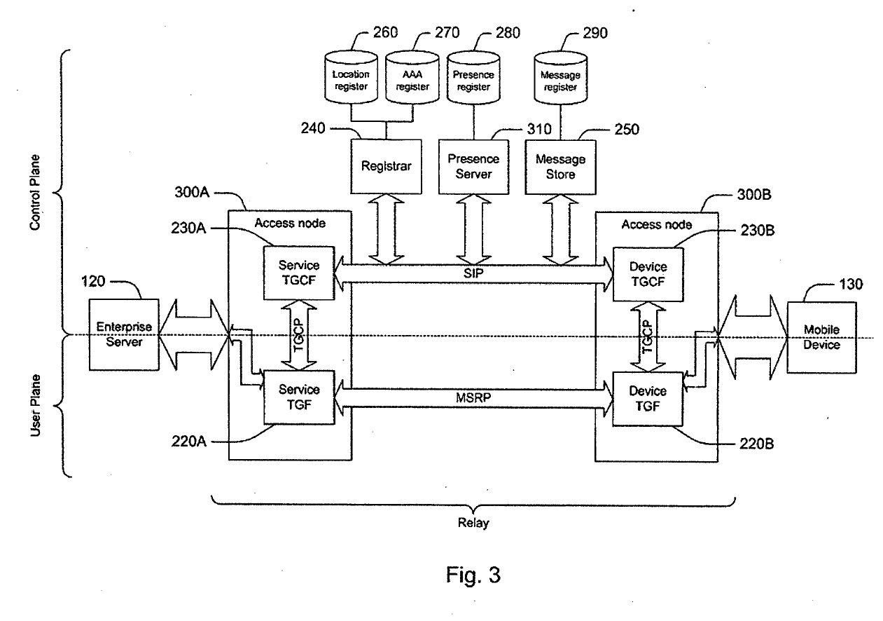

Communication between each endpoint and the associated access node depends on the type of Relay Client. For example, service entities such as enterprise server 120 may use a protocol such as Simple Mail Transfer Protocol (SMTP) or Extensible Messaging and Presence Protocol (XMPP) whereas mobile communication devices 130 may use a protocol such as Reliable UDP. As discussed above, such legacy protocols do not separate control signals from user data. Therefore, according to an aspect of the exemplary embodiment each Relay Tier-1 access node (separately identified in FIG. 3 by reference 300) separates the Control Plane and User Plane functions into a transport gateway control function, indicated as Transport Gateway Control 230 and a transport gateway function, indicated as Transport Gateway 220, respectively, as illustrated in FIGS. 2 and 3.

According to the exemplary embodiment, SIP is used as the Control Plane protocol for communication between access nodes 300 and relay services (Relay Tier-2), such as a Registrar 240, a Message Store 250 and a Presence Server 310 (FIG. 3). The central relay services: Registrar 240, Presence Server 310 and a Message Store 250 are supported by associated databases: MA Register 260, Location Register 270, Presence Register 280 and Message Register 290. The purpose of the Registrar 240 is to manage client location information. The purpose of Presence Server 310 is to support client presence state change notifications. The purpose of the Message Store 250 is to implement message persistence. The AAA Register 260 contains client configuration information and authentication credentials. The Location Register 270 contains client location (point-of-attachment) information. The Presence Register 280 contains presence subscription state information. The Message Register 290 contains messages.

The Service Transport Gateway Control (Service TGCF 230A) implements control plane functions for the access node functioning as handler of connections from Enterprise Servers 120 whereas the Device Transport Gateway Control (Device TGCF 230B) implements control plane functions for the access node functioning as handler of connections from Mobile Devices 130. Each Transport Gateway Control 230 is a ‘stateful’ function in that it maintains state for each and every session in which it is involved.

As discussed above, the User Plane functions of access nodes 300 include transport gateways, wherein the Service Transport Gateway (Service TGF 220A) implements the data transport functions for the access node functioning as handler of connections from Enterprise Servers 120 while the Device Transport Gateway (Device TGF 220B) implements the data transport functions for the access node functioning as handler of connections from Mobile Devices 130.

According to legacy protocols, relay clients are identified using application-specific identifiers (e.g. Email address in the case of SMPT or Jabber ID in the case of XMPP). However, in order to be used in SIP messages these addressing identifiers must be mapped to URIs. Therefore, according to the exemplary embodiment a SIP URI is generated from the application-specific identifiers according to the following format: sip:<email-address> or sip:<jabber-id>.

The term “session” as used in this specification means a set of two relay clients (e.g. enterprise server 120 and mobile communication device 130) and the data streams passing between them. A session is uniquely identified by the following attributes: the identifier of the relay client in the role of SIP caller, the identifier of the relay client in the role of SIP called party or callee, and the (set of) message payload type(s) carried by the session A consequence of the foregoing definition of “session” is that the establishment of sessions results in the exchange of routing information between a communicating pair of access nodes. As long as a session is active, each access node for a relay client participating in that session sends messages to the other access node in order to communicate with the other associated relay client. Furthermore, when the session is terminated, the routing information is automatically deleted. By using SIP, routing updates are explicitly signaled in the Control Plane. Caching of routing information is not required, since a session is established whenever a route needs to be discovered. Moreover, because routes are deleted upon session termination, ‘stale’ routes are not cached.

Since the legacy protocols used by Relay Clients (such as enterprise server 120 and mobile device 130) are stateless (i.e. not session-based), such protocols do not provide any mechanism for session initiation or termination. Therefore, according to an aspect of the exemplary embodiment implicit session registration and implicit session establishment are provided for session initiation and termination. More particularly, a SIP session is initiated in response to an access node 300 receiving the first message with a given source and destination addressing identifier and payload type. Likewise, a session is terminated responsive to a relay access node 300 determining that the traffic for a given source and destination addressing identifier and payload type has stopped, for example, responsive to an explicit message conforming to the legacy protocol for indicating the end of communication. Alternatively, if the legacy protocol uses a connection-oriented transport protocol (such as TCP), the access node may determine that data traffic has stopped when the transport connection is closed. Otherwise, the access node can use a simple time-out mechanism such that if no traffic has been received for a predetermined period of time, the access node determines that traffic has stopped.

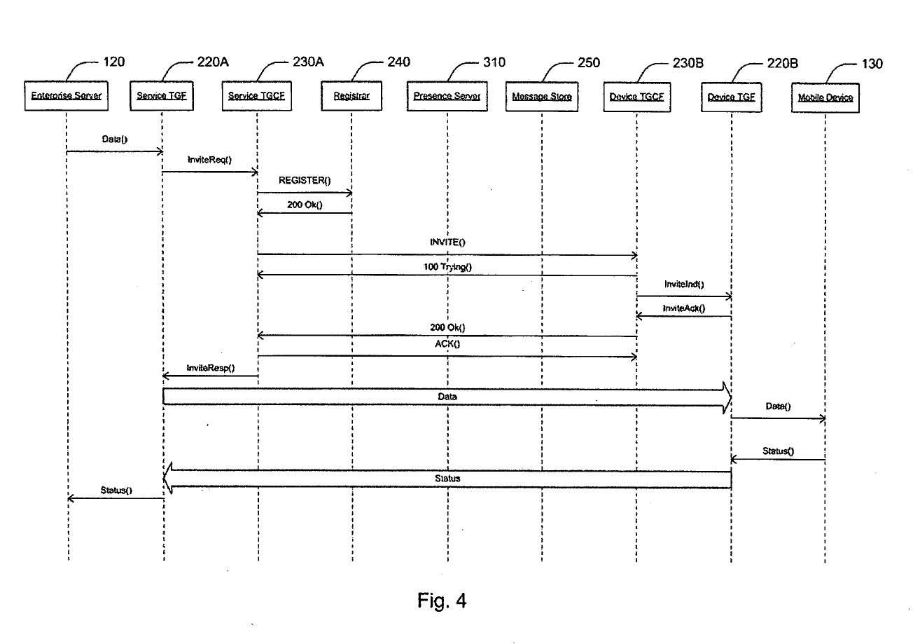

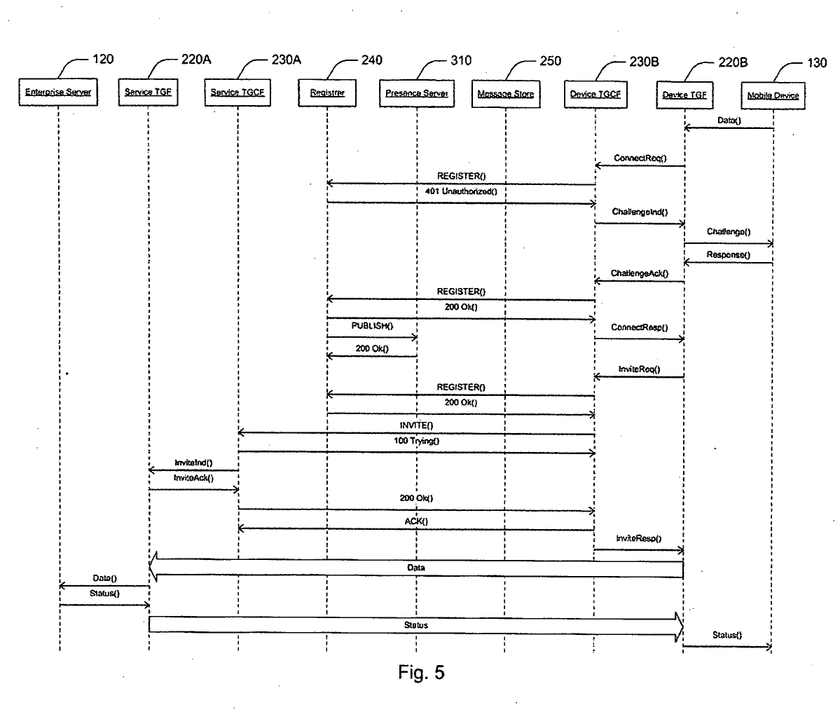

FIGS. 4 and 5 are message flow diagrams of exemplary message exchanges between relay clients, such as enterprise server 120 and handheld mobile communication device 130. In the following examples and description, enterprise server 120 is identified by identifier=bes123@rim.net, mobile device 130 is identified by identifier=0123abcd@rim.net, the access node 300A for SMTP or XMPP message handling to/from enterprise server 120 is identified as node1.na.rim.net having an IP address 10.1.0.4 and the access node 300B for wireless message transport handling to/from mobile communication device 130 is identified as node2.na.rim.net having an IP address 10.1.0.5. The Registrar 240 is identified by sip.na.rim.net/rf.na.rim.net having an IP address 10.1.0.1; Presence Server 310 is identified bysip:na.rim.net/pf.na.rim.net having an IP address 10.1.0.2; and Message Store 250 is identified by sip:na.rim.net/msf.na.rim.net having an IP address 10.1.0.3.

FIG. 4 is a message flow diagram showing an exemplary exchange of messages over the system 200 for pushing data from a service entity relay client, such as enterprise server 120, to handheld mobile communication device 130. The example of pushing data from enterprise server 120 to handheld mobile communication device 130 is exemplary and is described herein to illustrate the implicit registration and implicit session establishment features of the exemplary embodiment. In practice, a multitude of server initiated Control Plane operations may be performed, such as mutual authentication of the server 120 and the system 200, exchanging configuration information between the server 120 and the system 200, requesting and delivering mobile device state change notifications, etc., all of which rely on the implicit registration and implicit session establishment features described in FIG. 4.

In response to receiving a first message, denoted in FIG. 4 by Data( ), from enterprise server 120. The Service TGF 220A issues an invitation, denoted in FIG. 4 by InviteReq( ), to Service TGCF 230A via Transport Gateway Control Protocol (TGCP), thereby triggering the SIP session establishment procedure. In order for the ingress access node (Service TGCF 220A) to discover the egress access node to which the incoming message should be forwarded, a SIP REGISTER request is generated as a location query to the Registrar 240 (i.e. a SIP REGISTER request without any Contact header, and wherein the To header contains the query target), an example of which is as follows:

REGISTER sip:na.rim.net SIP/2.0
Via: SIP/2.0/UDP node1.na.rim.net:5060;branch=z9hG4bKrim17
Max-Forwards: 70
Ta: <sip:1234abcd@rim.net>
From: <sip:bes123@rim.net>;tag=123417
Call-ID: 246817@node1.na.rim.net
CSeq: 1017 REGISTER
Content-Length: 0

A 200 response from the Registrar 240 returns the result of the location query, wherein the Contact header contains the address of the egress node at which the destination client is currently registered, an example of which is as follows:

SIP/2.0 200 Ok
Via: SIP/2.0/UDP node1.na.rim.net:5060;branch=z9hG4bKrim17
;received=10.1.0.4
To: <sip:1234abcd@rim.net>;tag=43217
From: <sip:bes123@rim.net>;tag=123417
Call-ID: 246817@node1.na.rim.net
CSeq: 1017 REGISTER
Contact: <sip:1234abcd@10.1.0.5>;q=1.0;expires=3599
Content-Length: 0

The Service TGCF 230A then sends a SIP INVITE to the located egress node (i.e. Device TGCF 230B) to initiate SIP session establishment, an example of which is as follows:

INVITE sip:1234abcd@10.1.0.5 SIP/2.0
Via: SIP/2.0/UDP node1.na.rim.net:5060;branah=z9hG4bKrim18
Max-Forwards: 70
To: <sip:1234abcd@rim.net>
From: <sip:bes123@rim.net>;tag=123418
Call-ID: 246818@node1.na.rim.net
CSeq: 1018 INVITE
Allow:
ACK,BYE,CANCEL,INVITE,MESSAGE,NOTIFY,OPTIONS,UPDATE
Supported: timer
Require: timer
Session-Expires: 1800;refresher=uac
Content-Type: application/sdp
Content-Length: ...
v=0
o=bes123 2890844526 2890844526 IN IP4 10.1.0.4
s=−
c=IN IP4 10.1.0.4
t=0 0
m=application 40001 tcp msrp
a=sendrecv

It will be noted that SIP session timer support is indicated through Supported, Require and Session-Expires headers and that period refreshes are performed by the Service TGCF 230A in the role of user agent client (i.e. refresher=uac). The body of the INVITE request describes the Service TGCF 230A endpoint of the transport channel (using Session Description Protocol (SDP)), wherein the media type is “application”, the port number is 40001, the protocol is “tcp” and the encoding is “msrp”.

An optional 100 response indicates that the Device TGCF 230B has received and is processing the SIP INVITE request, for example as follows:

SIP/2.0 100 Trying
Via: SIP/2.0/UDP node1.na.rim.net:5060;branch=z9hG4bKrim18
;received=10.1.0.4
To: <sip:1234abcd@rim.net>;tag=432118
From: <sip:bes123@rim.net>;tag=123418
Call-ID: 246818@node1.na.rim.net
CSeq: 1018 INVITE
Content-Length: 0

A 200 response from the Device TGCF 230B indicates that it is willing to complete the session establishment, for example as follows.

SIP/2.0 200 Ok
Via: SIP/2.0/UDP node1.na.rim.net:5060;branch=z9hG4bKrim18
;received=10.1.0.4
To: <sip:1234abcd@rim.net>;tag=432118
From: <sip:bes123@rim.net>;tag=123418
Call-ID: 246818@node1.na.rim.net
CSeq: 1018 INVITE
Allow: ACK,BYE,CANCEL,INVITE,MESSAGE, NOTIFY,
OPTIONS,UPDATE
Supported: timer
Require: timer
Session-Expires: 1800;refresher=uac
Content-Type: application/sdp
Content-Length: . . .
v=0
o=1234abcd 2890844527 2890844527 IN IP4 10.1.0.5
s=−
c=IN IP4 10.1.0.5
t=0 0
m=application 40002 tcp msrp
a=sendrecv

The body of the 200 response describes the Device TGCF 230B endpoint of the transport channel (using Session Description Protocol (SDP)), wherein the media type is “application”, the port number is 40002, the protocol is “top” and the encoding is “msrp”.

The three-way handshaking required for SIP session establishment is completed by a SIP ACK from the Service TGCF 230A to the Device TGCF 230B, an example of which is as follows:

ACK sip:1234abcd@10.1.0.5 SIP/2.0
Via: SIP/2.0/UDP node1.na.rim.net:5060;branch=z9hG4bKrim19
Max-Forwards: 70
To: <sip:1234abcd@rim.net>;tag=432118
From: <sip:bes123@rim.net>;tag=123418
Call-ID: 246818@node1.na.rim.net
CSeq: 1019 ACK
Content-Length: 0

Once the SIP session has been established, the transport channel is open such that data and status messages can be exchanged directly between the Service TGF 220A and Device TGF 220B using a suitable protocol (e.g. Message Session Relay Protocol (MSRP)).

FIG. 5 is a message flow diagram showing an exemplary exchange of messages over the system 200 for sending data from handheld mobile communication device 130 to the enterprise server 120, when the device is not registered with the system 200 (and therefore there is no existing session), with authentication of the device 130 with the system 200. As with FIG. 4, the message exchange of FIG. 5 is exemplary and is described herein to illustrate another embodiment of the implicit registration and implicit session establishment features of the exemplary embodiment.

Upon receipt from mobile device 130 of the first data packet at the device TGF 220B, a mutual authentication message exchange sequence occurs. Normally, SIP authentication involves only two REGISTER transactions. The conventional SIP authentication model is extended to three REGISTER transactions, as shown in FIG. 5, to accommodate the exchange of authentication messages between the Device TGCF 230B and the Registrar 240.

An example of the first REGISTER request sent from the Device TGCF 230B to Registrar 240 is as follows:

REGISTER sip:na.rim.net SIP/2.0
Via: SIP/2.0/UDP node2.na.rim.net:5060;branch=z9hG4bKrim40
Max-Forwards: 70
To: <sip:1234abcd@rim.net>
From: <sip:1234abcd@rim.net>;tag=123440
Call-ID: 246840@node2.na.rim.net
CSeq: 1040 REGISTER
Contact: *;expires=0
Contact: <sip:1234abcd@10.1.0.5>;expires=3600
Content-Length: 0
Authorization: GCMPv1 pin=”1234abcd”

This first REGISTER request has two Contact headers. The first Contact header serves to clear all existing registrations, while the second Contact header contains new registration information. The Authorization header indicates that the device supports and requires authentication.

The Registrar 240 returns a 401 response, an example of which is as follows:

```
SIP/2.0 401 Unauthorized
Via: SIP/2.0/UDP node2.na.rim.net:5060;branch=z9hG4bKrim40
  ;received=10.1.0.5
To: <sip:1234abcd@rim.net>;tag=432140
From: <sip:1234abcd@rim.net>;tag=123440
Call-ID: 246840@node2.na.rim.net
CSeq: 1040 REGISTER
Content-Length: 0
WWW-Authenticate: Relay id=”1234abcd”
  ,challenge=<relay-challenge>
```

The exemplary 401 response returns an authentication challenge to the Device TGCF 230B. The WWW-Authenticate header contains id and challenge parameters, including a challenge string, ChallengeMessage( ), that is sent to the device 130 via Device TGF 220B.

An exemplary second REGISTER request from the Device TGCF 230B to Registrar 240 is as follows:

```
REGISTER sip:na.rim.net SIP/2.0
Via: SIP/2.0/UDP node2.na.rim.net:5060;branch=z9hG4bKrim41
Max-Forwards: 70
To: <sip:1234abcd@rim.net>
From: <sip:1234abcd@rim.net>;tag=123441
Call-ID: 246841@node1.na.rim.net
CSeq: 1041 REGISTER
Contact: *;expires=0
Contact: <sip:1234abcd@10.1.0.5>;expires=3600
Content-Length: 0
Authorization: Relay id=”1234abcd”
  ,challenge=<relay-challenge>
  ,response=<device-response>
```

The second REGISTER request carries an Authentication header with three parameters: id, challenge and response. The challenge parameter contains the challenge string that was sent to the device 130 and the response parameter contains the response string generated by the device 130.

The 200 Response from Registrar 240 indicates that the authentication and registration was successful. An example of the 200 Response is as follows:

SIP/2.0 200 Ok
Via: SIP/2.0/UDP node2.na.rim.net:5060;branch=z9hG4bKrim41
;received=10.1.0.5
To: <sip:1234abcd@rim.net>;tag=432141
From: <sip:1234abcd@rim.net>;tag=123441
Call-ID: 246841@node1.na.rim.net
CSeq: 1041 REGISTER
Contact: <sip:1234abcd@10.1.0.5>;expires=3600
Content-Length: 0

Upon completion of the authentication procedure, Registrar 240 publishes the new registration state of handheld device 130 to the Presence Server 310, for example as follows:

```
PUBLISH sip:1234abcd@rim.net SIP/2.0
Via: SIP/2.0/UDP rf.na.rim.net:5060;branch=z9hG4bKrim99
Max-Forwards: 70
To: <sip:1234abcd@rim.net>
From: <sip:1234abcd@rim.net>;tag=123499
Call-ID: 246899@rf.na.rim.net
CSeq: 9999 PUBLISH
Event: presence
Expires: 3600
Content-Type: application/reginfo+xml
Content-Length: . . .
<?xml version=“1.0” encoding=“UTF-8”?>
<presence xmlns=“urn:ietf:params:xml:ns:pidf”
    entity=“sip:1234abcd@rim.net”>
  <tuple id=“to”>
    <status>
      <basic>open</basic>
    </status>
  </tuple>
</presence>
```

The exemplary PUBLISH message contains an XML document in PIDF format that provides the new state of the handheld device 130. In the example above, the state is indicated as “open”, thereby indicating that the device 130 is in range of a wireless network 160. The Event header indicates a presence event, while the Expires header indicates the lifetime of the presence information.

An exemplary 200 response from PF 310 to Registrar 240 indicates that the PUBLISH request was successful, as follows;

SIP/2.0 200 Ok
Via: SIP/2.0/UDP node1.na.rim.net:5060;branch=z9hG4bKrim99
;received=10.1.0.1
To: <sip:1234abcd@rim.net>;tag=432199
From: <sip:1234abcd@rim.net>;tag=123499
Call-ID: 246899@rf.na.rim.net
SIP-Etag: asdf99
Expires: 3600
CSeq: 9999 PUBLISH
Content-Length: 0

Next, the ingress access node (Device TGCF 230B) needs to discover the egress access node to which the handheld data should be forwarded. Accordingly, a Device TGCF 230B sends a SIP REGISTER request to the Registrar 240 to query the location of the egress node. As discussed above in connection with FIG. 4, a SIP REGISTER message without any Contact header may be used to query the Registrar, with the query target in the To header, as follows:

REGISTER sip:na.rim.net SIP/2.0
Via: SIP/2.0/UDP node2.na.rim.net:5060;branch=z9hG4bKrim42
Max-Forwards: 70
To: <sip:bes123@rim.net>
From: <sip:1234abcd@rim.net>;tag=123442
Call-ID: 246842@node2.na.rim.net
CSeq: 1042 REGISTER
Contact: <sip:1234abcd@10.1.0.5>;expires=3600
Content-Length: 0

The 200 response from the Registrar 240 returns the result of the location query, wherein the Contact header contains the address of the egress node at which the destination client is currently registered, an example of which is as follows:

SIP/2.0 200 Ok
Via: SIP/2.0/UDP node2.na.rim.net:5060;branch=z9hG4bKrim42
;received=10.1.0.5
To: <sip:bes123@rim.net>;tag=432142
From: <sip:1234abcd@rim.net>;tag=123442
Call-ID: 1042 REGISTER
Contact: <sip:bes123@10.1.0.4>;q=1.0;expires=3599
Content-Length: 0

The Device TGCF 230B then sends a SIP INVITE to the located egress node (i.e. Service TGCF 230A) to initiate SIP session establishment, an example of which is as follows.

INVITE sip:bes123@10.1.0.4 SIP/2.0
Via: SIP/2.0/UDP node1.na.rim.net:5060;branch=z9hG4bKrim43
Max-Forwards: 70
To: <sip:bes123@rim.net>
From: <sip:1234abcd@rim.net>;tag=123443
Call-ID: 246843@node2.na.rim.net
CSeq: 1043 INVITE
Allow: ACK,BYE,CANCEL,INVITE,MESSAGE,NOTIFY,
OPTIONS,UPDATE
Supported: timer
Content-Type: application/sdp
Content-Length: . . .
v=0
o=bes123 2890844526 2890844526 IN IP4 10.1.0.5
s=−
c=IN IP4 10.1.0.5
t=0 0
m=application 40002 tcp msrp
a=sendrecv

It will be noted that SIP session timer support is indicated through Supported. The body of the INVITE request describes the Device TGCF 230B endpoint of the transport channel, wherein the media type is “application”, the port number is 40002, the protocol is “tcp” and the encoding is “msrp”.

An optional 100 response indicates that the Service TGCF 230A has received and is processing the SIP INVITE request, for example as follows:

SIP/2.0 100 Trying
Via: SIP/2.0/UDP node2.na.rim.net:5060;branch=z9hG4bKrim43
;received=10.1.0.5
To: <sip:bes123@rim.net>;tag=432143
From: <sip:abcd1234@rim.net>;tag=123443
Call-ID: 246843@node2.na.rim.net
CSeq: 1043 INVITE
Content-Length: 0

A 200 response from the Service TGCF 230A indicates that it is willing to complete the session establishment, for example as follows:

SIP/2.0 200 Ok
Via: SIP/2.0/UDP node2.na.rim.net:5060;branch=z9hG4bKrim43
;received=10.1.0.5
To: <sip:bes123@rim.net>;tag=432143
From: <sip:abcd1234@rim.net>;tag=123443
Call-ID: 246843@node2.na.rim.net
CSeq: 1043 INVITE
Allow: ACK,BYE,CANCEL,INVITE,MESSAGE,NOTIFY,
OPTIONS,UPDATE
Supported: timer
Require: timer
Session-Expires: 1800;refresher=uas
Content-Type: application/sdp
Content-Length: ...
v=0
o=1234abcd 2890844527 2890844527 IN IP4 10.1.0.4
s=−
c=IN IP4 10.1.0.4
t=0 0
m=application 40001 tcp msrp
a=sendrecv

The 200 response contains timer support indicated through Supported, Require and Session-Expires headers, wherein Service TGCF 230A is identified as performing periodic refreshes (in the role of user agent server (uas)). The body of the 200 response describes the Service TGCF 230A endpoint of the transport channel, wherein the media type is “application”, the port number is 40001, the protocol is “tcp” and the encoding is “msrp”.

A SIP acknowledgment (SIP ACK Request) completes the three-way handshaking procedure for SIP session establishment, as follows:

ACK sip:bes123@10.1.0.4 SIP/2.0
Via: SIP/2.0/UDP node2.na.rim.net:5060;branch=z9hG4bKrim44
Max-Forwards: 70
To: <sip:bes123@rim.net>;tag=432144
From: <sip:1234abcd@rim.net>;tag=123444
Call-ID: 246820@node1.na.rim.net
CSeq: 1044 ACK
Content-Length: 0

Once the SIP session has been established, the transport channel is open such that data and status messages can be exchanged directly between the Service TGF 220A and Device TGF 220B using a suitable protocol (e.g. Message Session Relay Protocol (MSRP)).

Certain adaptations and modifications of the described embodiments can be made. For example, although each message flow (uniquely identified by source and destination addressing identifiers and payload types) is associated with a unique SIP session it is not necessary that each session utilize a separate and distinct transport channel. Instead, since each message flow carries its own addressing identifiers, multiple flows can be multiplexed onto a single transport channel. However, for reasons of efficiency, in the exemplary embodiment all message flows between an ingress access node and an egress access node are carried in a single transport channel (e.g. a single UDP or TCP flow). Thus, a TCP connection can be established between the ingress and egress access nodes when the first SIP session is established such that subsequent SIP sessions between the same pair of nodes use the same TCP connection. In this way, datagram message flow between the pair of access nodes is multiplexed onto the single TCP connection.

Also, although SIP is used in the exemplary embodiment, other session-based communication protocols (e.g. H.323 or as yet un-established protocols) may be used.

The above discussed embodiments are considered to be illustrative and not restrictive.

What is claimed is:

1. A message routing overlay system for control and management of communications between endpoints, comprising:
a plurality of access nodes for communication with associated endpoints, each of said access nodes including a transport gateway for transport-layer transfer of data between said endpoints using a protocol that does not support session-based communications, and a transport gateway control for application-layer control of message routing of said transfer of data by establishing a communication session that is uniquely identified using source and destination identifiers and payload type of said data; and
a plurality of relay services for facilitating implicit session registration and implicit session establishment between a first one of said access nodes and a second one of said access nodes to initiate said communication session responsive to said first one of said access nodes receiving said source and destination identifiers and payload type from an associated endpoint and terminating said communication session responsive to determining that said transfer of data has stopped.

2. The message routing overlay system of claim 1, wherein said transport gateway control includes a user agent for communicating with said relay services to establish said communication session using a transport-independent signaling protocol.

3. The message routing overlay system of claim 2, wherein said transport-independent signaling protocol is Session Initiation Protocol (SIP) and said source and destination identifiers are mapped to SIP Uniform Resource Identifiers.

4. The message routing overlay system of claim 1, wherein said plurality of relay services includes a registrar for managing location information relating to said first and second access nodes.

5. The message routing overlay system of claim 1, wherein said plurality of relay services includes a presence function to support presence state change notifications relating to said first and second access nodes.

6. The message routing overlay system of claim 1, wherein said plurality of relay services includes a message store to implement message persistence between said first and second access nodes.

7. The message routing overlay system of claim 1, further including a load balancer intermediate each of said access nodes and associated endpoints.

8. An access node for connecting one of either a client or a server to a message relay system, comprising:
a transport gateway for transport-layer transfer of data between said one of either client or server and said message relay system using a protocol that does not support session-based communications; and
a transport gateway control for application-layer control of message routing of said transfer of data by establishing a communication session that is uniquely identified using source and destination identifiers and payload type of said data.

9. The access node of claim 8, wherein said application-layer control of message routing is in accordance with a transport-independent signaling protocol for locating endpoints within said message relay system, contacting said endpoints to determine willingness to establish said communication session, exchanging media information to allow the session to be established, and after said transfer of data tearing down said session.

10. The access node of claim 9, wherein said transport-independent signaling protocol is Session Initiation Protocol (SIP) and said source and destination identifiers are mapped to SIP Uniform Resource Identifiers.

11. The access node of claim 9, wherein said client is a wireless device and said transport gateway control implements control plane functions for said access node functioning as a wireless transport handler.

12. A method of control and management of communications between endpoints, comprising:
receiving data at a first access node from a first one of said endpoints using a protocol that does not support session-based communications;
initiating a communication session between said first access node and a second access node associated with a second endpoint using a transport-independent signaling protocol, wherein said session is uniquely identified using source and destination identifiers and payload type of said data received from said first one of said endpoints;
during said communication session between said first access node and said second access node controlling routing of data transfer between said first and second endpoints; and
terminating said communication session responsive to determining that said transfer of data has stopped.

13. The method of claim 12, wherein said transport-independent signaling protocol is Session Initiation Protocol (SIP) and said source and destination identifiers are mapped to SIP Uniform Resource Identifiers.

14. The method of claim 13, wherein initiating said communication session includes:
transmitting a location query from said access node to a registrar for discovering said second access node;
returning a response from said registrar to said first access node that contains an address of said second access node;
sending an invitation from said first access node to said second access node at said address to initiate said communication session;
sending a further response from said second access node to said first access node indicating willingness to complete establishment of the communication session;
sending an acknowledgement from said first access node to said second access node; and
opening a transport channel for exchanging data directly between said first endpoint and said second endpoint using a further protocol that does not support session-based communications.

15. The method of claim 14, wherein said location query comprises a SIP REGISTER request without any Contact header and containing a query target in a To header thereof.

16. The method of claim 14, wherein said address is contained in a Contact header of said response.

18. The method of claim 14, wherein said invitation comprises a SIP INVITE including session timers and a description for identifying entity type of said second endpoint.

19. The method of claim 14, wherein said further response comprises a SIP 200 response containing descriptions for identifying entity types of said first and second endpoints.

20. The method of claim 14, wherein prior to transmitting said location query said first access node and registrar complete a mutual authentication message exchange sequence occurs.
